(19) United States
(12) Patent Application Publication
(10) Pub. No.: US 2004/0235424 A1
(43) Pub. Date: Nov. 25, 2004

(54) System and method for controlling a mobile terminal located remote from a user

(76) Inventor: Jong-Kwang Kim, Kumi-shi (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/847,330

(22) Filed: May 18, 2004

(30) Foreign Application Priority Data
May 20, 2003 (KR) 2003-31991

(51) Int. Cl. H04Q 7/20

(52) U.S. Cl. 455/68; 455/466; 455/556.2

(57) ABSTRACT

A system and method for controlling a second mobile terminal located in a remote place by using a first mobile terminal. The first mobile terminal transmits a short message service (SMS) message, and the second mobile terminal receives the SMS message. In the system and method, the first mobile terminal sets a control command, and transmits the set control command to the second mobile terminal. The second mobile terminal performs an operation corresponding to the control command received from the first mobile terminal.

### PRIORITY

This application claims priority under 35 U.S.C. § 119 to an application entitled “Method for Controlling Mobile Terminal Located in Remote Place” filed in the Korean Intellectual Property Office on May 20, 2003 and assigned Serial No. 2003-31991, the contents of which are incorporated herein by reference.

### BACKGROUND OF THE INVENTION

1. Field of the Invention

The present invention relates generally to a system and method for controlling a mobile terminal, and in particular, to a system and method for controlling a mobile terminal located remote from a user.

2. Description of the Related Art

As memory capacity of a mobile terminal is increased, a user tends to register more information in the mobile terminal and use more functions. Thus, the mobile terminal requires increased power. One of the factors of increasing power consumption of the mobile terminal is transmission/reception of data related to a call. When the user is absent for a long time while the mobile terminal is powered on, electric power of the mobile terminal may become exhausted. In this case, information temporarily stored in the mobile terminal is deleted. That is, when a battery is completely dissipated, data written in a synchronous dynamic random access memory (SDRAM) may be deleted. In addition, when a user is away from their mobile terminal which is optioned for a bell mode and is located where silence is required, the mobile terminal will generate a bell sound upon receiving an incoming call, breaking the silence. Nevertheless, presently, the user cannot control his or her mobile terminal while being away from the mobile terminal.

### SUMMARY OF THE INVENTION

It is, therefore, an object of the present invention to provide a system and method for enabling a user to control his or her mobile terminal even in a remote place by using another mobile terminal.

To achieve the above and other objects, the invention provides a system and method for controlling, by a first mobile terminal, a second mobile terminal located in a remote place. The first mobile terminal transmits a short message service (SMS) message, and the second mobile terminal receives the SMS message. In the system and method, the first mobile terminal sets a control command, and transmits the set control command to the second mobile terminal. The second mobile terminal performs an operation corresponding to the control command received from the first mobile terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an example of a mobile terminal according to an embodiment of the present invention;

FIG. 2 is a detailed block diagram illustrating an example of the power supply in the mobile terminal of FIG. 1;

FIG. 3 is a flowchart illustrating an example of a procedure for setting a control command and transmitting the control command in a mobile terminal according to an embodiment of the present invention;

FIGS. 4A to 4F illustrate examples of information displayed on a display of a mobile terminal according to an embodiment of the present invention;

FIG. 5 illustrates an example of a format of Short Message Service (SMS) data transmitted by a mobile terminal according to an embodiment of the present invention; and

FIG. 6 is a flowchart illustrating an example of a procedure for performing an operation corresponding to a received command in a mobile terminal according to an embodiment of the present invention.

### DETAILED DESCRIPTION OF THE PREFERRED EMBODIMENT

An embodiment of the present invention will now be described in detail with reference to the accompanying drawings. In the drawings, the same or similar elements are denoted by the same reference numerals. In the following description, a detailed description of known functions and configurations incorporated herein has been omitted for conciseness.

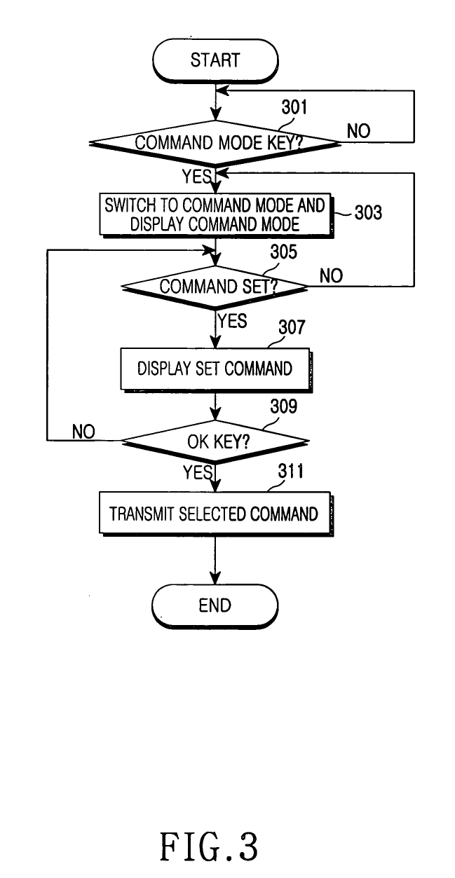

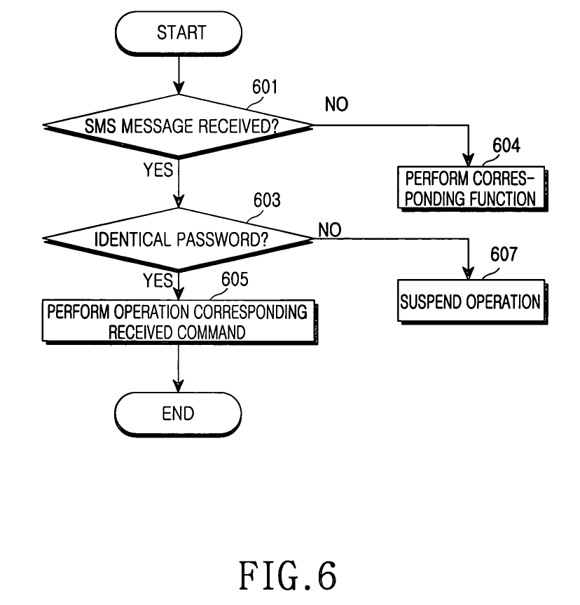

Although a plurality of mobile terminals can be used in the invention, it will be assumed herein that two mobile terminals are used, for the purpose of simplicity. In addition, since the two mobile terminals are identical in their internal structure, only one of the two mobile terminals will be described. FIG. 3 is a flowchart illustrating an operation of a first mobile terminal (controlling (or calling) side), and FIG. 6 is a flowchart illustrating an operation of a second mobile terminal (controlled (or called) side).

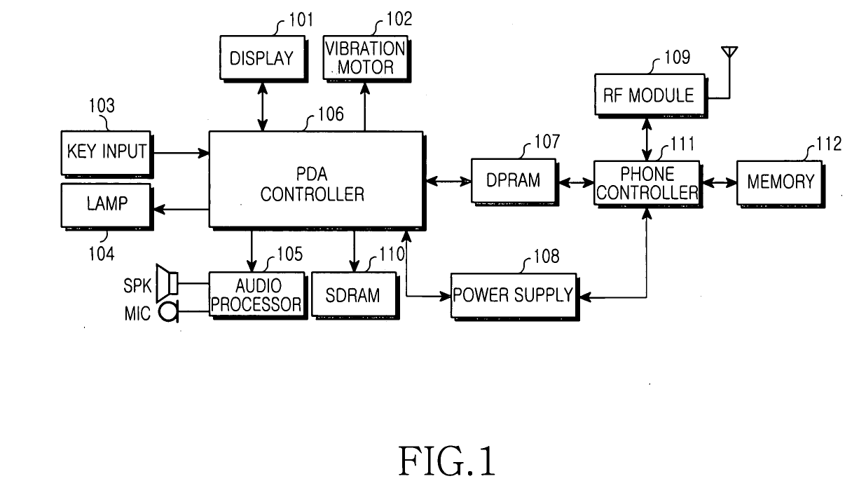

FIG. 1 is a block diagram illustrating an example of a mobile terminal according to an embodiment of the present invention. Referring to FIG. 1, a radio frequency (RF) module 109 provides a communication function for the mobile terminal, and includes an RF transmitter (not shown) for up-converting a frequency of a transmission signal and amplifying the up-converted transmission signal, and an RF receiver (not shown) for low-noise-amplifying a received signal and down-converting a frequency of the low-noise-amplified signal. A memory 112 comprises a program memory (not shown) and a data memory (not shown). The program memory stores programs for controlling a general operation of phone-related elements, and programs for controlling an operation in a command mode according to an embodiment of the present invention. The data memory stores data generated during execution of the programs. The data can include commands to be set, and the commands can include but is not limited to a ‘phone power on/off’ command, a ‘bell on/off’ command, and a ‘vibration motor on/off’ command.

A phone controller 111 controls the RF module 109 and the memory 112, and communicates with a personal digital assistant (hereinafter referred to as “PDA”) controller 106 via a dual port random access memory (RAM) (hereinafter referred to as “DPRAM”) 107. The DPRAM 107 is a type of buffer, and speeds up communication between the phone controller 111 and the PDA controller 106. The PDA controller 106 controls the overall operation of the mobile terminal. In addition, the PDA controller 106 receives a key signal generated from a key input section 103 as a command, and performs the command. The phone controller 111 controls parts related to transmission/reception of data, and the PDA controller 106 controls internal elements including the phone controller 111.

A display 101 can be practiced with a liquid crystal display (hereinafter referred to as “LCD”), a light-emitting diode display or any other suitable display, and displays various information according to a control signal from the PDA controller 106. In addition, the display 101 can be implemented with a touch screen, and in this case, the display 101 can also be used as an input device. A vibration motor 102 vibrates according to a control signal from the PDA controller 106. A light emitting diode (LED) or a laser diode (LD) can be used for a lamp 104, and the lamp 104 is turned on or off according to a control signal from the PDA controller 106. The key input section 103 includes alphanumeric keys for inputting text and numeric information, a navigation key for selecting information, a Call key, an End key, and function keys for setting various functions. The function keys include a command mode key according to an embodiment of the present invention, and even a combination of the navigation key and the alphanumeric keys can serve as the command mode key. An audio processor 105 processes an input audio signal detected by a microphone (MIC), and also processes an output audio signal which is provided to a speaker (SPK). Further, the audio processor 105 can output a bell sound.

A synchronous dynamic random access memory (hereinafter referred to as “SDRAM”) 110 is a memory device operating in response to a main clock used by the PDA controller 106. The SDRAM 110 operates at a higher rate than an existing RAM, since a data bus is provided and respective RAMs therein are synchronized with each other. That is, since the PDA controller 106 is synchronized with a storage area, no waiting time is required in accessing the storage area. Therefore, the PDA controller 106 can access a storage area at high speed. A power supply 108 provides electric power to internal elements of the mobile terminal.

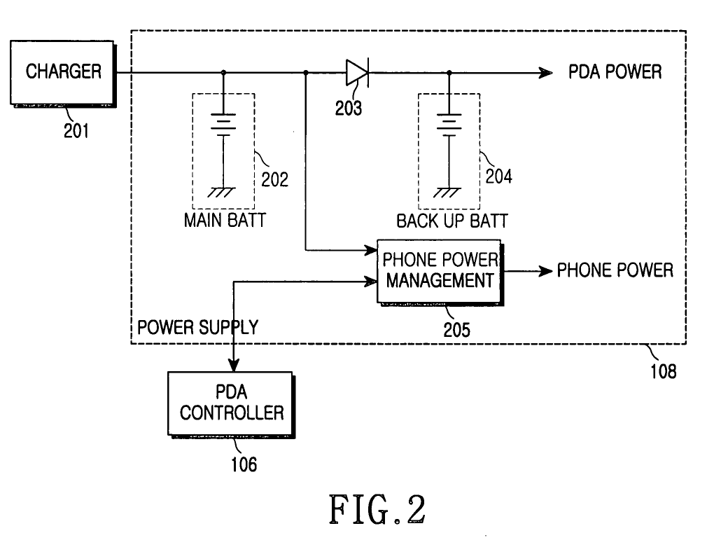

FIG. 2 is a detailed block diagram illustrating an example of the power supply in the mobile terminal according to an embodiment of the present invention. An operation of the power supply 108 will be described with reference to FIGS. 1 and 2.

A charger 201 includes a charging circuit for charging a mobile terminal, and provides electric power to the power supply 108. The power supply 108 charges a main battery 202 and a backup battery 204 with the electric power provided from the charger 201. After being charged, the main battery 202 provides electric power to PDA-related elements and phone-related elements. The “PDA-related elements” refer to elements connected to the PDA controller 106, and include, for example, the display 101, the SDRAM 110, the vibration motor 102 and the lamp 104. The “phone-related elements” refer to elements related to data transmission/reception, and include, for example, the RF module 109 and the phone controller 111. A phone power manager 205 manages electric power of the phone-related elements, and is controlled by the PDA controller 106.

If the main battery 202 is discharged, the backup battery 204 provides electric power only to the PDA-related elements excluding the phone-related elements. The electric power of the backup battery 204 is provided only to the PDA-related elements because power consumption by the phone-related elements is higher than power consumption by the PDA-related elements, i.e., power consumption by the transmission/reception-related elements is relatively higher. A diode 203 prevents the electric power of the backup battery 204 from being provided to the phone-related elements.

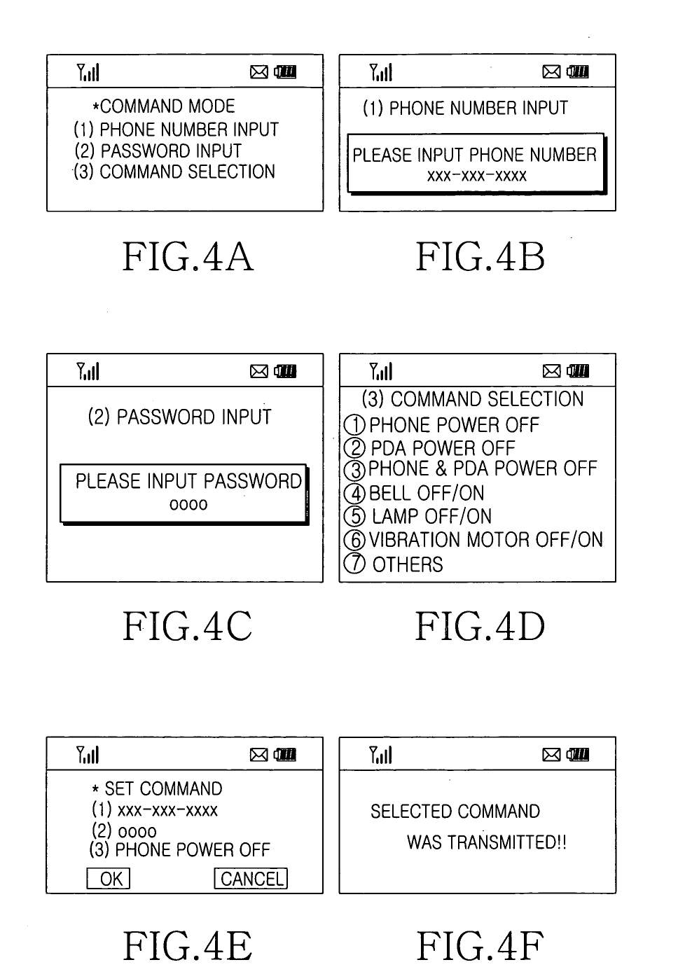

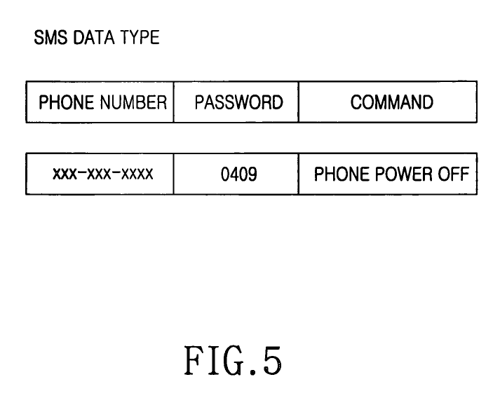

FIG. 3 is a flowchart illustrating an example of a procedure for setting a control command and transmitting the control command in a mobile terminal according to an embodiment of the present invention. FIGS. 4A to 4F illustrate examples of information displayed on a display of a mobile terminal according to an embodiment of the present invention. FIG. 5 illustrates an example of a format of Short Message Service (SMS) data transmitted by a mobile terminal according to an embodiment of the present invention. A method of setting a control command for controlling a target mobile terminal will be described with reference to FIGS. 1, 3, 4 and 5.

If a user manipulates keys of the key input section 103, the PDA controller 106 determines in step 301 whether a key signal is received from the key input section 103. As a result of the determination, if the received key signal is not a command mode key signal, the PDA controller 106 maintains an initial state, and if the received key signal is a command mode key signal, the PDA controller 106 proceeds to step 303. In step 303, the PDA controller 106 switches to a command mode, controls the display 101 to display the command mode thereon, and then proceeds to step 305. The display 101 can display the command mode as shown in FIG. 4A. The command mode is a mode in which a control command is sent to a target mobile terminal to be controlled, and the command mode includes a ‘phone number input’ menu, a ‘password input’ menu, and a ‘command selection’ menu. In step 305, the PDA controller 106 determines whether a command is set. As a result of the determination, if no command is set, the PDA controller 106 repeats the step 303, and if a command is set, the PDA controller 106 proceeds to step 307.

In a method of setting a command, the user must set the ‘phone number input’ menu, the ‘password input’ menu, and the ‘command selection’ menu. If the user selects the ‘phone number input’ menu in FIG. 4A, the PDA controller 106 controls the display 101 to display a screen as shown in FIG. 4B. If the user inputs a phone number of the target mobile terminal in a pop-up window of FIG. 4B, the PDA controller 106 controls the display 101 to display the input phone number. In addition, if the user selects the ‘password input’ menu in FIG. 4A, the PDA controller 106 controls the display 101 to display a screen as shown in FIG. 4C. If the user inputs a password of the target mobile terminal in a pop-up window of FIG. 4C, the PDA controller 106 controls the display 101 to display the input password. Furthermore, if the user selects the ‘command selection’ menu in FIG. 4A, the PDA controller 106 controls the display 101 to display a screen as shown in FIG. 4D. If the user selects one of the command items shown in FIG. 4D, the PDA controller 106 sets the selected command. Thereafter, the PDA controller 106 controls the display 101 to display a screen as shown in FIG. 4E. The display 101 can display a phone number ‘xxx-xxx-xxxx’, a password ‘oooo’, and a command ‘phone power off’.

In step 309, the PDA controller 106 determines whether a key signal is received from the key input section 103. As a result of the determination, if the received key input signal is not an OK key signal, the PDA controller 106 repeats the step 305, and if the received key input is an OK key signal, the PDA controller 106 proceeds to step 311. In step 311, the PDA controller 106 controls the DPRAM 107 and the phone controller 111 to transmit the selected command. In a method of transmitting a set command, the DPRAM 107 transmits a command received from the PDA controller 106 to the phone controller 111. The phone controller 111 controls the RF module 109 to transmit the command received from the DPRAM 107 to the input phone number (of the target mobile terminal). The RF module 109 transmits the input phone number ‘xxx-xxx-xxxx’ through an SMS message. The SMS message includes a phone number, a password and a command, as shown in the data format of FIG. 5. In the data format, sequence of the data fields is subject to change. If the user chooses an OK key of the key input section 103 in FIG. 4E, the PDA controller 106 controls the display 101 to display “selected command was transmitted!!!” as shown in FIG. 4F.

FIG. 6 is a flowchart illustrating an example of a procedure for performing an operation corresponding to a received command in a mobile terminal according to an embodiment of the present invention. How the mobile terminal operates upon receiving a command will be described with reference to FIGS. 1, 2 and 6. Here, it is assumed that the mobile terminal of FIG. 1 is a target mobile terminal that has received the command.

In step 601, the phone controller 111 determines whether an SMS message is received. As a result of the determination, if the received SMS message is a non-command-related SMS message, the phone controller 111 proceeds to step 604, and if the received SMS message is a command-related SMS message, the phone controller 111 proceeds to step 603. The “non-command-related SMS message” refers to an SMS message related to a text message and a voice message. In step 604, the phone controller 111 performs a corresponding function. The “corresponding function” refers to a general function of handling conventional text message or voice message. The phone controller 111 delivers information on a password ‘0409’ and a command ‘phone power off’ included in the SMS message of FIG. 5, to the PDA controller 106 via the DPRAM 107.

In step 603, the PDA controller 106 determines whether the password delivered from the phone controller 111 is identical to its own password. As a result of the determination, if the passwords are not identical, the PDA controller 106 proceeds to step 607, and if the passwords are identical, the PDA controller 106 proceeds to step 605. In step 607, the PDA controller 106 suspends an operation related to the password and command information provided from the phone controller 111.

In step 605, the PDA controller 106 performs an operation corresponding to the received command. For example, if the received command is a ‘phone power off’ command, the PDA controller 106 controls the phone power manager 205 to cut off electric power applied to the phone-related elements. The user can select one of the various commands shown in FIG. 4D. For example, a command for cutting off electric power of PDA-related elements is a ‘PDA power off’ command. A command for turning on or off a bell is a ‘Bell off/on’ command. A command used to turn on or off a lamp is a ‘Lamp off/on’ command. In addition, a command used to activate or inactivate a vibration motor is a ‘Vibration Motor off/on’ command. By selecting one of the commands, a user can control his or her mobile terminal located remote from the user by using another mobile terminal. Instead of selecting one command, the user can select multiple commands. For example, the user can simultaneously select the ‘phone power off’ command and the ‘Bell off’ command, and the target mobile terminal then simultaneously turns off electric power of the phone-related elements and the bell sound.

Although the embodiments of the present invention have been disclosed for illustrative purposes, those skilled in the art will appreciate that various modifications, additions and substitutions are possible, without departing from the scope of the invention. Although the invention has been described with reference to a PDA phone as the mobile terminal, the invention can also be applied to a mobile phone or a data transmission/reception terminal. For example, in a data transmission/reception terminal, it is possible to control a remote mobile terminal by setting a command for controlling the remote mobile terminal and transmitting the set command to the remote mobile terminal along with data. Therefore, the present invention is not limited to the above-described embodiments, but the present invention is defined by the claims which follow, along with their full scope of equivalents.

What is claimed is:

1. A method for controlling, by a first mobile terminal, a second mobile terminal located in a remote place, the first mobile terminal transmitting a short message service (SMS) message and the second mobile terminal receiving the SMS message, the method comprising the steps of:
setting a control command by the first mobile terminal;
transmitting the set control command from the first mobile terminal to the second mobile terminal; and
performing by the second mobile terminal an operation corresponding to the control command received from the first mobile terminal.

2. The method of claim 1, wherein the step of setting a control command comprises the steps of:
inputting a phone number to which the control command is to be transmitted;
inputting a password; and
selecting the control command.

3. The method of claim 2, wherein the step of selecting a control command comprises the step of selecting at least one of a phone power off command, a personal digital assistant (PDA) power off command, a bell off/on command, a lamp off/on command and a vibration motor off/on command.

4. The method of claim 1, wherein the step of transmitting the set control command comprises the step of transmitting the control command along with an SMS message.

5. The method of claim 1, wherein the step of performing an operation corresponding to the control command comprises the steps of:
determining whether the input password is identical to its own password; and
performing an operation corresponding to the control command if the passwords are identical.
